(19) United States
(12) Patent Application Publication
(10) Pub. No.: US 2016/0066396 A1
(43) Pub. Date: Mar. 3, 2016

(54) WIRELESS SWITCH

(71) Applicant: SAMSUNG ELECTRO-MECHANICS CO., LTD., Suwon-si (KR)

(72) Inventors: In Wha JEONG, Suwon-si (KR); Jong Heum PARK, Suwon-si (KR); Hyung Jin LIM, Suwon-si (KR)

(73) Assignee: SAMSUNG ELECTRO-MECHANICS CO., LTD., Suwon-si (KR)

(21) Appl. No.: 14/837,417

(22) Filed: Aug. 27, 2015

(30) Foreign Application Priority Data
Sep. 1, 2014 (KR) 10-2014-0115724
Apr. 22, 2015 (KR) 10-2015-0056483

(51) Int. Cl. H05B 37/02; H02J 5/00

(52) U.S. Cl. CPC H05B 37/0272; H02J 5/005

(57) ABSTRACT

A wireless switch includes a first energy harvester including a circuit, and a second energy harvester configured to open or close the circuit of the first energy harvester unit by an external operation. Hence, by using this approach, the wireless switch is able to operate without a requirement for providing a separate power supply.

### CROSS-REFERENCE TO RELATED APPLICATION(S)

This application claims the benefit under 35 USC 119(a) of Korean Patent Application Nos. 10-2014-0115724 filed on Sep. 1, 2014, and 10-2015-0056483 filed on Apr. 22, 2015 in the Korean Intellectual Property Office, the entire disclosures of which are incorporated herein by reference for all purposes.

### BACKGROUND

1. Field

The following description relates to a wireless switch including an energy harvester.

2. Description of Related Art

Generally, a wireless lighting control system includes a lighting part in which a power module and a communications module are embedded, a wireless controller, a network device that connects the lighting part and the wireless controller, and an illumination sensor.

However, since a separate wireless lighting controller and a separate network device are used in a current wireless lighting control system, a structure has become complicated and manufacturing costs have increased.

It is potentially difficult to apply a wireless lighting control system in homes, offices, or the like, due to the problem as described above with respect to the approach of using a separate wireless lighting controller and a separate network device.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect of the present examples provides a wireless switch using an energy harvester.

According to an aspect of the present examples, a wireless switch includes a first energy harvester unit including an initially closed circuit, and a second energy harvester unit configured to open a closed circuit or close an open circuit of the first energy harvester unit by an external operation.

In one general aspect, a wireless switch includes a first energy harvester including a circuit, and a second energy harvester configured to open the circuit of the first energy harvester or close the circuit of the first energy harvester device by an external operation.

The wireless switch may further include an electricity storage device that accumulates energy generated by at least one of the first and second energy harvesters.

The first energy harvester may have a magnetic induction type energy harvester structure.

The first energy harvester may include a core member of which one side is open, a coil member formed on the core member, and a magnet member situated at one side of an open portion of the core member.

The second energy harvester may have a piezoelectric type energy harvester structure.

The second energy harvester may include a thin film member, a support member situated to support a center or an edge of the thin film member, a piezoelectric member situated on the thin film member, and a driving member situated on the thin film member and configured to press the edge or the center of the thin film member on a portion of the thin film member in which the driving member does not face the support member.

The first energy harvester generates a voltage having a level lower than a level of a voltage generated by the second energy harvester.

In another general aspect, a wireless switch includes a first energy harvester that includes an actuator that opens a closed circuit or closes an open circuit of the first energy harvester, and a second energy harvester that generates energy required to operate the actuator.

The first energy harvester may include a core member of which one side is open, a coil member situated on the core member, and a magnet member situated at one side of an open portion of the core member.

The actuator may be situated between the core member and the magnet member.

The second energy harvester may include a thin film member, a support member situated to support a center or an edge of the thin film member, a piezoelectric member situated on the thin film member, and a driving member situated on the thin film member and configured to press the center or the edge of the thin film member on a portion of the thin film member in which the driving member does not face the support member.

The second energy harvester may further include electrodes situated on the thin film member and connected to the piezoelectric member.

The support member may be situated to support the edge of the thin film member.

The driving member may be situated to press the center of the thin film member.

The thin film member may have a circular or hemispherical shape.

The thin film member may radially extend in different directions.

Other features and aspects will be apparent from the following detailed description, the drawings, and the claims.

### BRIEF DESCRIPTION OF THE DRAWINGS

FIG. 1 is a front diagram of a wireless switch according to an example.

FIG. 2 is a configuration diagram of a wireless switch according to an example.

FIG. 3 is a configuration diagram of an energy harvester according to an example.

FIG. 4 is a configuration diagram of an energy harvester according to another example.

FIG. 5 is a configuration diagram of a second energy harvester unit according to an example.

FIG. 6 is an operation state diagram of the second energy harvester unit illustrated in FIG. 5.

FIG. 7 is a perspective diagram of a second energy harvester unit according to another example.

FIG. 8 is a cross-sectional diagram of the second energy harvester unit taken along line A-A of FIG. 7;

FIG. 9 is a plan diagram of a second energy harvester unit according to another example.

FIG. 10 is a plan diagram of the second energy harvester unit according to another example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

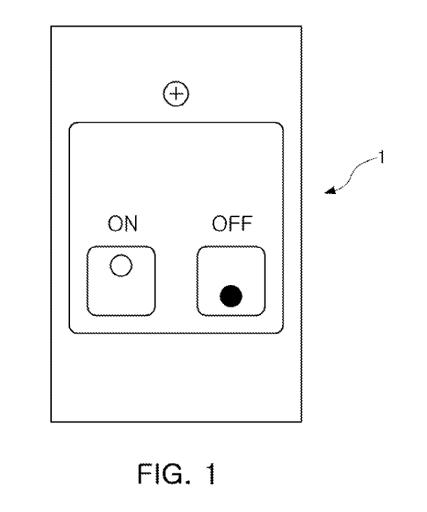

A wireless switch according to an example is described with reference to the example of FIG. 1.

A wireless switch 1 is installed in an area in which a user is able to easily operate the wireless switch 1. For example, the wireless switch 1 is installed on a wall surface, or the like. However, this is only an example, and in other examples the wireless switch 1 is installed in other places. The wireless switch 1 transmits control signals operating a device disposed at a far-away distance from the wireless switch 1. For example, the wireless switch 1 transmits different wireless signals depending on switching operations of the user so as to control an on/off operation of a lighting device situated on a ceiling. This is only an example, and a lighting device whose operation is controlled by the wireless switch 1 is potentially situated in other locations than a ceiling. However, a long-distance device controlled by the wireless switch 1 is not limited to the lighting device. As alternative examples, the wireless switch 1 potentially controls an air conditioning unit, a sound system, or the like. For example, these devices are also optionally situated on a ceiling. However, these are only examples, and other appropriate devices are controlled by the wireless switch 1 in other examples, and the other appropriate devices are situated on a ceiling or another appropriate location.

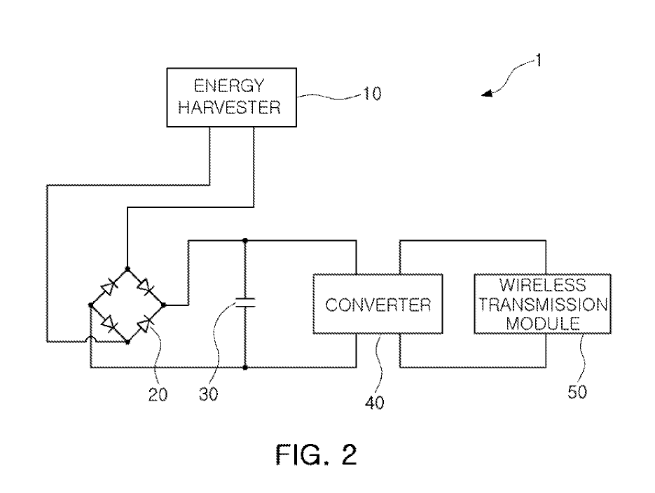

A main configuration of the wireless switch according to the example is described with reference to the example of FIG. 2.

The wireless switch 1, according to the example of FIG. 2, includes an energy harvester 10, a rectifier 20, a capacitor 30, a converter 40, and a wireless transmission module 50.

In the example of FIG. 2, the energy harvester 10 provides driving energy required to operate the wireless switch 1. For example, the energy harvester 10 provides power required to operate the wireless transmission module 50.

The rectifier 20 converts the energy or current generated by the energy harvester 10. For example, the rectifier 20 converts an alternating current or pulsed current generated from the energy harvester 10 into direct current.

The capacitor 30 stores the energy generated from the energy harvester 10. For example, the capacitor 30 accumulates the current generated from the energy harvester 10 so that the amplitude of the current is sufficient to operate the wireless transmission module 50.

The converter 40 converts a voltage generated by the capacitor 30 into a voltage suitable for the wireless transmission module 50. For example, the converter 40 is a DC/DC converter converting a first DC voltage into a second DC voltage.

The wireless transmission module 50 transmits wireless signals. For example, the wireless transmission module 50 transmits the wireless signals when input power of the energy harvester 10 is transferred through the rectifier 20 and the converter 40.

The wireless transmission module 50 controls an external electronic device. For example, the wireless transmission module 50 transmits wireless signals turning on/off a light emitting diode (LED) lamp installed at a far-away distance.

The wireless switch 1 configured as described above controls an external electronic device without a separate driving power. Therefore, the wireless switch 1 according to the present example is installed to thereby be used in a place where power connection is difficult or complicated, and is thus hard to access physically.

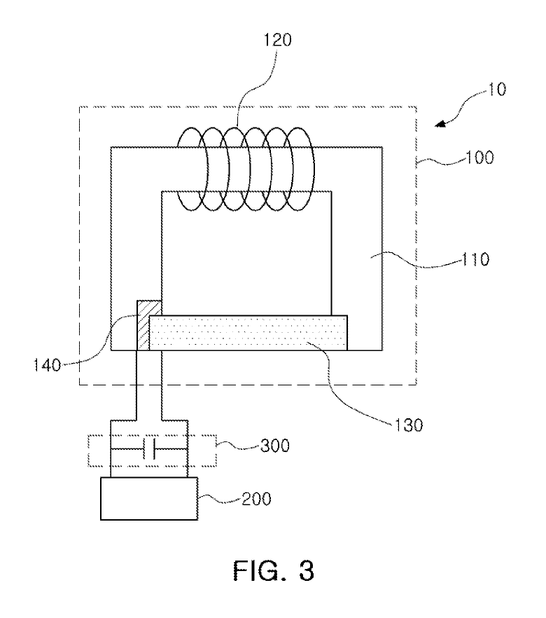

The energy harvester according to the example is described further with reference to FIG. 3.

The energy harvester 10 includes a first energy harvester unit 100 and a second energy harvester unit 200. However, a configuration of the energy harvester 10 is not limited to the above-mentioned units. Thus, the energy harvester 10 optionally includes appropriate additional components that aid in its operation. For example, the energy harvester 10 further includes an electricity storage unit 300.

In an example, the energy harvester 10 has a serial structure. For example, in the energy harvester 10, the first energy harvester unit 100 and the second energy harvester unit 200 are connected in series. In the energy harvester 10 configured as described above, the second energy harvester unit 200 provides driving force for the first energy harvester unit 100. However, a structure of the energy harvester 10 is not limited thereto. For example, the structure of the energy harvester 10 is potentially changed so that the first energy harvester unit 100 provides driving force of the second energy harvester unit 200.

In the example of FIG. 3, the first energy harvester unit 100 generates a substantially low voltage. For example, the first energy harvester unit 100 is a magnetic induction type energy harvester. The first energy harvester unit 100 configured as described above is advantageous for generating energy required to drive a small sized electronic component.

For example, the first energy harvester unit 100 includes a core member 110, a coil member 120, and a magnet member 130. The core member 110, the coil member 120, and the magnet member 130 constitute a closed circuit. For example, the core member 110, the coil member 120, and the magnet member 130 constitute a circuit forming a predetermined magnetic field.

The core member 110 has a shape in which one side is open. For example, the core member 110 may have a ‘ [symbol] ’ shape. However, the shape of the core member 110 is not limited thereto, and other appropriate differently shaped core members 110 are used in other examples.

In the example of FIG. 3, the coil member 120 is disposed on the core member 110. For example, the coil member 120 is disposed at a bisection point of the core member 110. The coil member 120 is provided in plural, in that multiple coils are included that are coiled around the core member 110. For example, two or more coil members 120 are wound around the core member 110.

The magnet member 130 is disposed so that the first energy harvester unit 100 forms a closed circuit. As an example, the magnet member 130 is disposed at one side of the open portion of the core member 110. As another example, the magnet member 130 is disposed to have one side connected to the core member 110 and the other side connected to an actuator 140.

For example, the magnet member 130 disposed as described above generates a predetermined magnetic field through an interaction with the coil member 120.

The first energy harvester unit 100 includes the actuator 140. For example, the first energy harvester unit 100 includes the actuator 140 for selectively separating the magnet member 130 from the core member 110.

In an example, the actuator 140 includes a piezoelectric element. A piezoelectric element uses the piezoelectric effect to convert a mechanical force into electric energy. For example, the actuator 140 uses characteristics of the piezoelectric element. In an inactivation state, the actuator 140 maintains the first energy harvester unit 100 in a closed circuit state, and in an activation state, the actuator 140 maintains the first energy harvester unit 100 in an open circuit state. However, the actuator potentially operates in the opposite manner. In such an example, in the activation state, the actuator 140 maintains the first energy harvester unit 100 in the closed circuit state, and in the inactivation state, the actuator 140 maintains the first energy harvester unit 100 in the open circuit state.

The first energy harvester unit 100 configured as described above generates energy when the first energy harvester unit 100 is converted from the closed circuit state into the open circuit state. Here, the generated energy is used as driving energy of the wireless transmission module as described above.

However, in the example of FIG. 3, by contrast to the first energy harvester unit 100, the second energy harvester unit 200 generates a substantially high voltage. For example, the second energy harvester unit 200 is a piezoelectric type energy harvester. The second energy harvester unit 200 as describe above is suitable for providing a strong driving force.

In an example, the second energy harvester unit 200 enables energy generation by the first energy harvester unit 100. For example, the second energy harvester unit 200 changes the closed circuit state of the first energy harvester unit 100. For example, the second energy harvester unit 200 activates the actuator 140 to change the closed circuit state of the first energy harvester unit 100 into the open circuit state.

In this example, the second energy harvester unit 200 is connected to the actuator 140 of the first energy harvester unit 100 to operate the actuator 140. For example, the second energy harvester unit 200 generates energy required to operate the actuator 140.

Thus, the second energy harvester unit 200 changes a switching operation of the user into energy. For example, the second energy harvester unit 200 includes a piezoelectric member capable of converting the switching operation of the user into energy.

The electricity storage unit 300 is disposed between the first and second energy harvester units 100 and 200 and accumulates energy generated from the second energy harvester unit 200.

In the energy harvester 10 configured as described above, since a configuration converting the switching operation of the user into energy and a configuration generating energy required in the wireless transmission module are separated from each other, operational reliability of the wireless switch is improved.

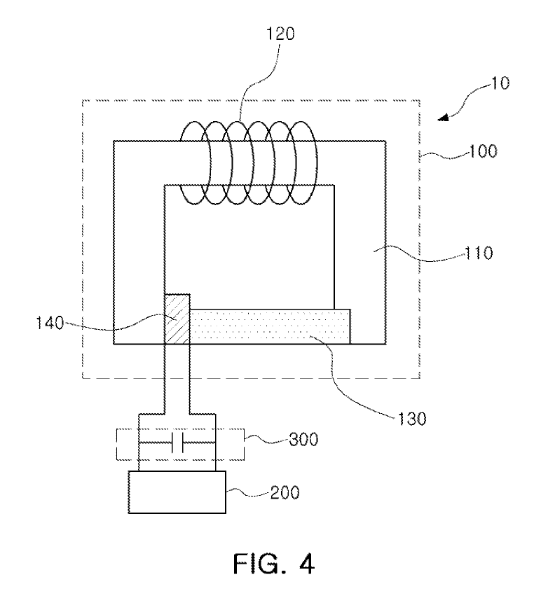

Hereinafter, an energy harvester according to another example is described with reference to FIG. 4.

The energy harvester 10 according to the present example is distinguished from the energy harvester according to the example described above by a structure in which an actuator 140 is situated. For example, in the example of FIG. 4, the actuator 140 is situated between a core member 110 and a magnet member 130. As the actuator 140 configured as described above is potentially extended or contracted in a left and right direction, based on FIG. 4, the actuator connects the core member 110 and the magnet member 130 to each other or separates the core member 110 and the magnet member 130 from each other.

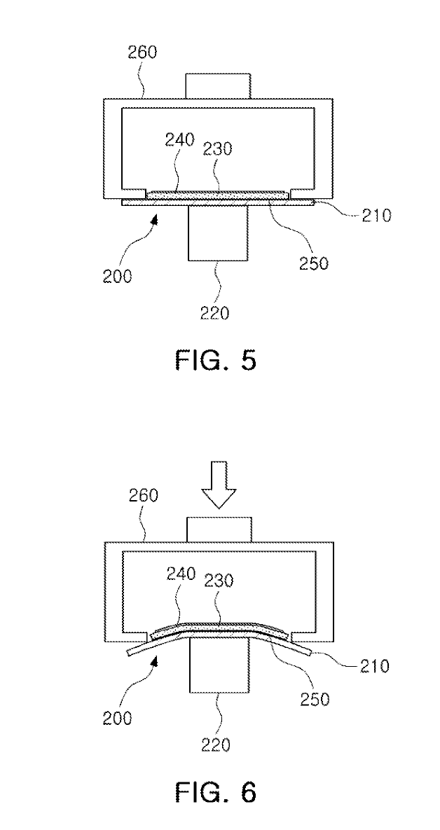

The second energy harvester unit according to the example is further described with reference to FIGS. 5 and 6.

The second energy harvester unit 200, according to the example, includes a thin film member 210, a support member 220 supporting the thin film member 210, a piezoelectric member 230 provided on the thin film member 210, an upper electrode 240 provided on one surface of the piezoelectric member 230, a lower electrode 250 provided on the other surface of the piezoelectric member 230, and a driving member 260 generating displacement in the thin film member 210.

For example, the thin film member 210 is formed in a plate shape, has elasticity, and is supported by the support member 220.

The support member 220 is disposed on a central portion of a lower surface of the thin film member 210 to support the thin film member 210. Therefore, when external force is applied to one side and the other side of the thin film member 210 based on the support member 220, displacement is generated in portions of the thin film member 210 to which external power is applied.

The piezoelectric member 230 is provided on the thin film member 210. Therefore, when displacement is generated in the thin film member 210, displacement is also generated in the piezoelectric member 230, and thus a piezoelectric effect generating a potential difference is generated.

For example, when a displacement is generated in the thin film member 210, a displacement is also generated in the piezoelectric member 230 provided on the thin film member 210, and thus electrical polarization occurs in the piezoelectric member 230. Therefore, voltage is generated in the upper electrode 240 provided on one surface of the piezoelectric member 230, and an output current generated by the voltage is used as driving power of the wireless transmission module 50.

In examples, the piezoelectric member 230 is formed of lead zirconate titanate, barium titanate (BaTiO₃), lead titanate (PbTiO₃), lithium niobate (LiNbO₃), silicon oxide (SiO₂), or the like. However, these are only example materials, and the piezoelectric member 230 is optionally formed of other appropriate potential materials.

For example, the lower electrode 250 is provided in order to generate a potential difference and is provided on the other surface of the piezoelectric member 230 so as to correspond to the upper electrode 240.

An operational state of the second energy harvester unit is further described with reference to FIG. 6.

When the user presses the driving member 260 of the second energy harvester unit 200, external force is applied to one side and the other side of the thin film member 210 corresponding to the driving member 260, and thus displacement is generated in the one side and the other side of the thin film member 210.

Thus, when a displacement is generated in one side and the other side of the thin film member 210 based on the support member 220, a displacement is also generated in one side and the other side of the piezoelectric member 230 in response thereto. As a result, a voltage is generated in the upper electrode 240 disposed on one surface of the piezoelectric member 230.

In a case in which both sides of the thin film member 210 are displaced as described above, a displacement distance is relatively small and a voltage equal to or larger than that in a case of displacing only one of both sides of the thin film member 210 is obtained, and thus impacts applied to the thin film member 210 are minimized.

Therefore, the second energy harvester unit, according to the present examples, decreases a lifetime shortening phenomenon that occurs due to damage to the thin film member.

The voltage generated in the upper electrode 240 is used as a driving power of the wireless transmission module 50, and the wireless transmission module 50 transfers wireless communications signals to an external electronic device, depending on a displacement of the thin film member by the driving member.

Next, a second energy harvester unit according to another example is described. For reference, hereinafter, components that are the same as those in the above-mentioned example are denoted by the same reference numerals and a description thereof will be omitted for brevity.

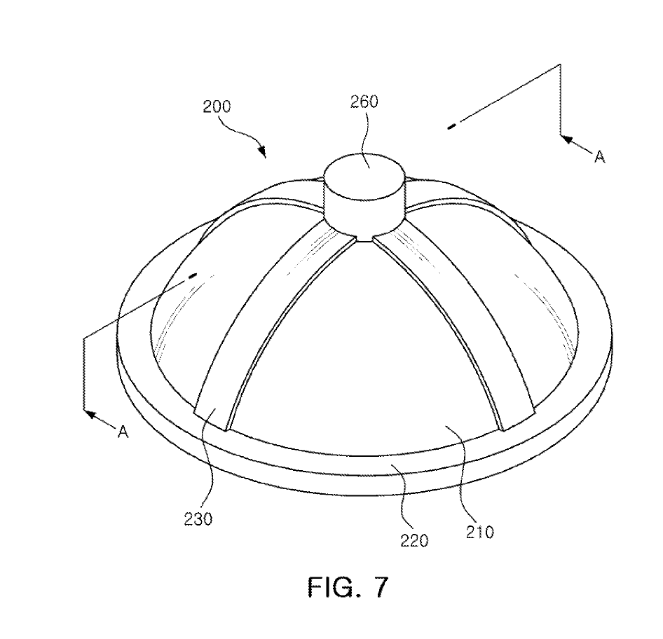

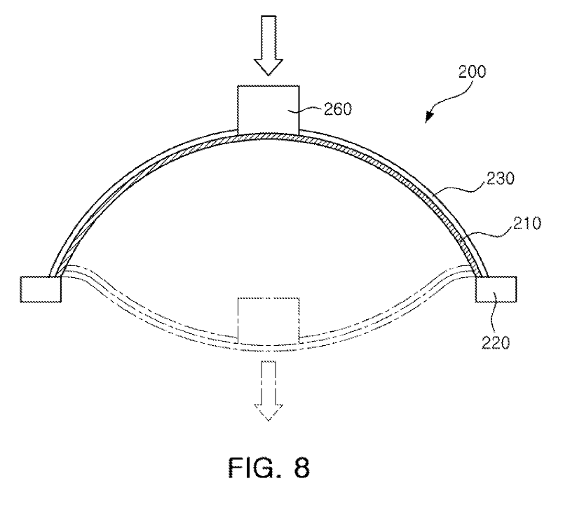

The second energy harvester unit according to another example is described with reference to FIGS. 7 and 8.

The second energy harvester unit 200, according to the present example, is distinguished from the second energy harvester unit according to the examples described above by aspects of a shape of a thin film member 210. For example, the thin film member 210 according to the present example has a hemispherical shape.

In an example, the thin film member 210 having the shape as described above has excellent restoring force.

As an example, the thin film member 210 is rapidly restored to an original state after a pressing operation of the user. As another example, the thin film member 210 constantly maintains an original state even after the user frequently uses a wireless switch.

Therefore, it is effective to use the second energy harvester unit 200 according to the present example in a place and a use case in which a switch is frequently used.

The second energy harvester unit 200, according to the present example, is distinguished from the second energy harvester unit according to the example described above by a shape of a support member 220. For example, the support member 220, according to the present example, is formed to be elongated in a ring shape along an edge of the hemispherical thin film member 210.

The support member 220 having the shape as described above is advantageous for stably supporting the hemispherical thin film member 210.

The second energy harvester unit 200 configured as described above obtains significant piezoelectric energy by a single switching operation.

As an example, a piezoelectric member 230 generates piezoelectric energy when the thin film member 210 is deformed from a state in which the thin film member 210 has a convex upward shape to a state in which the thin film member 210 has a concave downward shape. As another example, the piezoelectric member 230 generates piezoelectric energy when the thin film member 210 is restored from the state in which the thin film member 210 has a concave downward shape to the state in which the thin film member 210 has a convex upward shape.

Therefore, the second energy harvester unit 200, according to the present example, generates a significant amount of energy by a single operation.

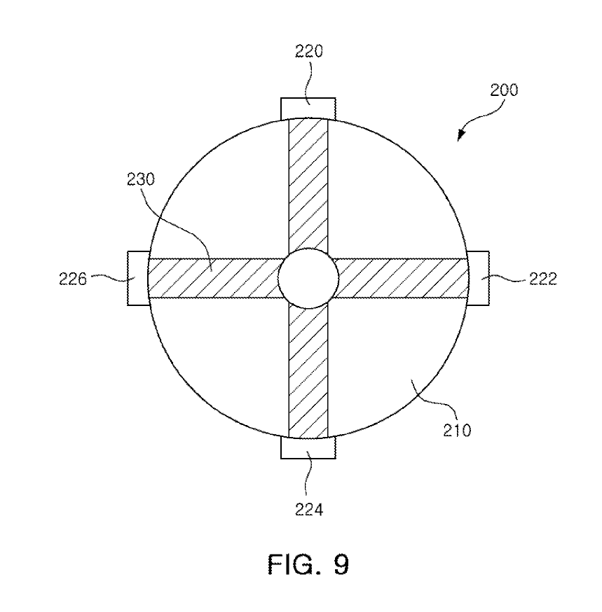

A second energy harvester unit according to another example is described with reference to FIG. 9.

The second energy harvester unit 200, according to the present example, is distinguished from the second energy harvester units according to the examples described above by a shape of a thin film member 210. For example, the thin film member 210, according to the present example, has a circular shape.

In this example, a piezoelectric member 230 extends from the center of the thin film member 210 in a radial direction. For example, a diameter of the thin film member 210 and a length of the piezoelectric member 230 are chosen to be the same as each other.

Support members 220, 222, 224, and 226 support only portions of the thin film member 210. For example, the support members 220, 222, 224, and 226 are disposed on portions of the thin film member in which end portions of the piezoelectric member 230 are positioned.

Since the thin film member 210 and the piezoelectric member 230 have a plate shape, the second energy harvester unit 200 configured as described above are easily manufactured.

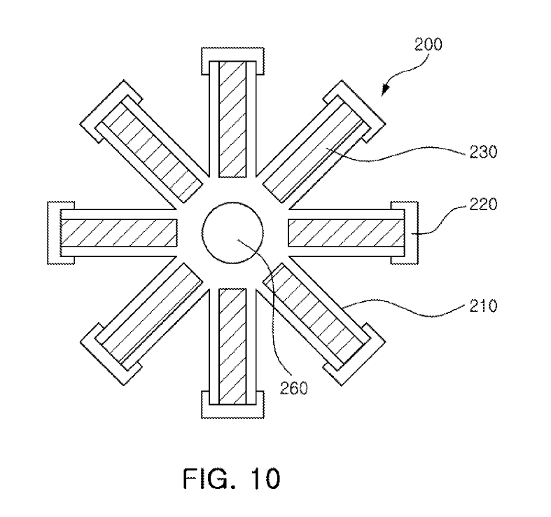

A second energy harvester unit according to another example is described further with reference to FIG. 10.

The second energy harvester unit 200, according to the present example, is distinguished from the second energy harvester units according to the examples described above by a shape of a thin film member 210.

The thin film member 210, according to the present example, is radially extended in relation to a driving member 260. As an example, the thin film member 210 is extended in eight directions in relation to the driving member 260. As another example, the thin film member 210 is extended in six directions in relation to the driving member 260.

Support members 220 are disposed on ends of the thin film member 210, respectively. As an example, the support members 220 are disposed on distal ends of the thin film member 210 respectively extended in several directions. In this case, the number of support members 220 is the same as the number of extended branches of the thin film member 210. As another example, the support members 220 connect all of the distal ends of the thin film member 210 respectively extended in several directions to each other. In an example, the support member 220 has a circular shape having a diameter equal to the maximum length of the thin film member 210.

A piezoelectric member 230 is formed on the thin film member 210. As an example, the piezoelectric member 230 is separately formed on the thin film member 210 respectively extended in several directions. As another example, the piezoelectric member 230 is selectively formed on portions of the thin film member 210 respectively extended in several directions.

In the second energy harvester unit 200 configured as described above, since spaces for a plurality of piezoelectric members 230 are formed in the thin film member 210, the number of piezoelectric members 230 formed on the thin film member 210 is easily adjusted depending on a magnitude of piezoelectric energy to be required.

As set forth above, according to examples in the present disclosure, a wireless switch that does not require a separate power supply is provided.

Unless indicated otherwise, a statement that a first layer is “on” a second layer or a substrate is to be interpreted as covering both a case where the first layer directly contacts the second layer or the substrate, and a case where one or more other layers are disposed between the first layer and the second layer or the substrate.

Words describing relative spatial relationships, such as “below”, “beneath”, “under”, “lower”, “bottom”, “above”, “over”, “upper”, “top”, “left”, and “right”, may be used to conveniently describe spatial relationships of one device or elements with other devices or elements. Such words are to be interpreted as encompassing a device oriented as illustrated in the drawings, and in other orientations in use or operation. For example, an example in which a device includes a second layer disposed above a first layer based on the orientation of the device illustrated in the drawings also encompasses the device when the device is flipped upside down in use or operation.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A wireless switch comprising:
a first energy harvester comprising a circuit; and
a second energy harvester configured to open the circuit of the first energy harvester or close the circuit of the first energy harvester device by an external operation.

2. The wireless switch of claim 1, further comprising an electricity storage device that accumulates energy generated by at least one of the first and second energy harvesters.

3. The wireless switch of claim 1, wherein the first energy harvester has a magnetic induction type energy harvester structure.

4. The wireless switch of claim 1, wherein the first energy harvester comprises:
a core member of which one side is open;
a coil member formed on the core member; and
a magnet member situated at one side of an open portion of the core member.

5. The wireless switch of claim 1, wherein the second energy harvester has a piezoelectric type energy harvester structure.

6. The wireless switch of claim 1, wherein the second energy harvester comprises:
a thin film member;
a support member situated to support a center or an edge of the thin film member;
a piezoelectric member situated on the thin film member; and
a driving member situated on the thin film member and configured to press the edge or the center of the thin film member on a portion of the thin film member in which the driving member does not face the support member.

7. The wireless switch of claim 1, wherein the first energy harvester generates a voltage having a level lower than a level of a voltage generated by the second energy harvester.

8. A wireless switch comprising:
a first energy harvester comprising an actuator that opens a closed circuit or closes an open circuit of the first energy harvester; and
a second energy harvester that generates energy required to operate the actuator.

9. The wireless switch of claim 8, wherein the first energy harvester comprises:
a core member of which one side is open;
a coil member situated on the core member; and
a magnet member situated at one side of an open portion of the core member.

10. The wireless switch of claim 9, wherein the actuator is situated between the core member and the magnet member.

11. The wireless switch of claim 8, wherein the second energy harvester comprises:
a thin film member;
a support member situated to support a center or an edge of the thin film member;
a piezoelectric member situated on the thin film member; and
a driving member situated on the thin film member and configured to press the edge or the center of the thin film member on a portion of the thin film member in which the driving member does not face the support member.

12. The wireless switch of claim 11, wherein the second energy harvester further comprises electrodes situated on the thin film member and connected to the piezoelectric member.

13. The wireless switch of claim 11, wherein the support member is situated to support the edge of the thin film member.

14. The wireless switch of claim 13, wherein the driving member is situated to press the center of the thin film member.

15. The wireless switch of claim 14, wherein the thin film member has a circular or hemispherical shape.

16. The wireless switch of claim 15, wherein the thin film member radially extends in different directions.
